(19) United States
(12) Patent Application Publication
(10) Pub. No.: US 2005/0171840 A1
(43) Pub. Date: Aug. 4, 2005

(54) Online commerce in buyer items with incidental free raffle tickets

(76) Inventor: Steven Rinehart, Bountiful, UT (US)

Correspondence Address: John W. L. Ogilvie;THORPE NORTH & WESTERN, LLP, P.O. Box 1219, Sandy, UT, 84091-1219, US

(21) Appl. No.: 10/769,671

(22) Filed: Jan. 30, 2004

(51) Int. Cl. G06F 17/60

(52) U.S. Cl. 705/14

(57) ABSTRACT

Methods and systems are disclosed in which raffle tickets are given away with online purchases of other items. Ticket holders may use such a ticket in any one of several raffles. Raffles can be canceled for lack of interest. Charitable donations may be made by an online commerce entity which manages an online marketplace in which the raffle tickets are given away. Also disclosed are methods performed by raffle item suppliers, buyers or suppliers of non-raffle items, and charities, and related systems.

### BACKGROUND OF THE INVENTION

Raffle tickets have been sold offline and online with the stated goal of raising funds for charitable organizations. Items donated to a charity have been raffled, by the charity or by a raffle event organizer acting on behalf of the charity, and funds raised from ticket sales have been donated to the charity. Raffles may be subject to licensing requirements and/or other governmental regulation, with the stated goal of ensuring the integrity of raffles and maximizing the financial returns to charities.

Raffle entries have been given away freely (e.g., “no purchase required”) in exchange for demographic and/or entrant contact information which could then be used to generate sales leads through email, direct mail, or other advertising. Raffle entries have also been given away at no charge as an incentive to purchase services, such as fitness club memberships, and in exchange for answering surveys. Sweepstakes entries have been given away in exchange for contact information and voluntary exposure to advertising.

Availability of the Internet has spurred creativity in many ways. Some online business models and other commerce architectures that were previously impractical or undreamed of have been described, implemented, and in some cases widely copied. Many or all of the raffle activities noted above have also been performed using the Internet. However, an enormous variety of other activities also take place on the Internet. Because it is often difficult to predict with accuracy the practicality and particular features of a contemplated Internet-based commerce architecture, innovation on the Internet is an on going endeavor.

Bearing this in mind, FIG. 1 is a diagram illustrating a previously known commerce architecture 100 which includes an online auction provider 102, a poster 104 who posts information about an item 106 in an online auction 108, and bidders 110 who submit bids 112 on the item in the online auction. Differences between the present invention and the commerce architectures shown in FIGS. 1 and 2 will become apparent. However, these two Figures and other presentations of prior art are presented as an exhaustive summary of the prior art or the ways in which it differs from the present invention.

Note also that this background was prepared after a search that was guided by knowledge of the present invention. That is, the background was written in hindsight based on knowledge of the present invention. This background information is recited to assist the reader to be aware of various forms of prior art activity. The recitation of specific features within the general background should be understood to identify such features in their isolated environment of actual practice. It is not intended that these isolated practices should be viewed collectively. Accordingly, it does not follow from the mere fact that disparate teachings are described together in this background that one of skill in the art would have been motivated to combine those teachings.

With continuing attention to FIG. 1, the bidders may be required to submit registration information 114, such as contact information and perhaps a credit card authorization or other bid fee payment, to the online auction provider. The poster may also be required to submit registration information 116 to the online auction provider, as well as a description 118 of the item, and a posting fee 120 to have the item posted in an auction. Information sent between these people is often embodied in signals and files, for instance, as it travels over network links and other familiar communications infrastructure to 122 and from 124 the auction provider.

The auction is unsuccessful if no bid high enough to meet the poster's asking price is submitted. At the conclusion of a successful auction, the auction provider identifies the auction winner, e.g., the bidder with the highest bid submitted before the auction was closed. The auction provider sends a notice 126 to the winning bidder, and the auction provider sends the poster a notice and the bidder's contact information 128 so that the poster and the bidder can conclude the transaction. The poster sends 130 the item 106 to the winning bidder, e.g., by postal mail or courier, and the winning bidder sends 132 the poster the agreed upon payment (winning bid amount) 134 for the item. This concludes the transaction.

FIG. 2 is a diagram illustrating a previously known commerce architecture 200 which includes a charity 202, a raffle item donor 204, a raffle organizer 206, and raffle ticket buyers 208. The donors 204 donate items 210 for the benefit of the charity. The donated items may be goods, services, or both. The charity receives funds 212 that are at least a portion of the payments 214 made by the ticket buyers for raffle tickets 216. In some cases the charity organizes the raffle itself; this could be reflected in a diagram similar to FIG. 2 which has the organizer and the charity shown as coextensive, and the funds 212 are implicitly the same as the ticket payments 214. The raffle may be held at a predetermined date regardless of how many tickets 216 have been sold, or it may be held after enough tickets have been sold to provide a desired level of funds to the charity. A winner is selected by randomly choosing one of the tickets; in some raffles multiple winners are selected to win prizes that can be shared or divided. The winning ticket holder is notified 218 and is given the prize 210 that was donated for the raffle.

### SUMMARY OF THE INVENTION

The present invention can be summarized by considering the activities of various participants in the recited raffle process. These activities are generally represented by the following perspectives of the invention, based on possible participation of an online commerce entity, a raffle item supplier, a buyer of the raffle item, a charity, and a supplier of a buyer item. Specifically:

Some embodiments of the invention provide an online commerce method performed by an online commerce entity which manages an online marketplace in which buyers purchase buyer items. The method in question comprises giving buyers raffle tickets at no charge incidental to their purchase in the online marketplace of buyer items which are not raffle tickets; listing online raffle items which are not raffle tickets; accepting raffle tickets submitted by buyers for listed raffle items; tracking which buyers submit raffle ticket(s) for each of a plurality of raffle items; and randomly selecting a raffle winner from among the buyers who are participating in a given raffle, the winner being selected only if the level of raffle tickets submitted for participation in that raffle reaches a positive qualifying threshold.

Some embodiments of the invention provide an online commerce method performed by a raffle item supplier who has legal rights in a raffle item. The method in question comprises authorizing an online commerce entity to offer the raffle item in an online raffle for which tickets are given away at no charge in response to buyer item purchases made in an online marketplace; agreeing to transfer legal rights to a raffle winner if one is randomly selected from among parties who are given raffle tickets in the online marketplace; and retaining the legal rights if the raffle is canceled due to a relative lack of interest from parties to whom raffle tickets are given in the online marketplace, the parties having a choice of raffles, with a corresponding choice of different raffle items, in any one of which raffles a particular raffle ticket may be used.

Some embodiments of the invention provide an online commerce method performed by a buyer. The method in question comprises purchasing a buyer item in an online marketplace; receiving a raffle ticket which is given at no charge incidentally to the purchase of the buyer item and which is usable in any one of a plurality of raffles which offer different raffle items as their respective prizes; and submitting the raffle ticket for use in one of the plurality of raffles to increase the buyer's chance of being selected as a winner of that raffle.

Some embodiments of the invention provide an online commerce method performed by a charity. The method in question comprises entering an agreement with an online commerce entity which expressly permits the online commerce entity to publicize an arrangement between the charity and the online commerce entity by at least publicizing that the charity will receive donations from the online commerce entity in response to buyer participation in a raffle whose tickets are given at no charge to buyers in response to their purchase of buyer items in an online marketplace managed by the online commerce entity; and receiving a donation from the online commerce entity pursuant to the arrangement between the charity and the online commerce entity.

Some embodiments of the invention provide an online commerce method performed by a buyer item supplier. The method in question comprises entering an agreement with an online commerce entity which expressly permits the online commerce entity to advertise a buyer item for sale in an online marketplace that provides a buyer with at least one raffle ticket at no charge when the buyer buys the buyer item and allows the buyer to submit the ticket in any one of a plurality of raffles; and supplying a description of the buyer item to the online commerce entity to assist in advertising the item in the online marketplace.

Some embodiments of the invention provide an online commerce system, comprising modules such as: a purchasing module (e.g., software) for buyers to purchase online buyer items that are not raffle tickets; a ticket-providing module (e.g., software) which gives buyers raffle tickets at no charge incidental to their online purchase of buyer items; a ticket-accepting module (e.g., software) which (i) accepts raffle tickets submitted by buyers and (ii) tracks which buyers submit raffle ticket(s) for each of a plurality of raffle items; and a winner-selecting module (e.g., software) which randomly selects a raffle winner from among the buyers who are participating in a given raffle, the winner being selected only if the level of raffle tickets submitted for participation in that raffle reaches a positive qualifying threshold. Some embodiments further include the hardware for running the identified software. Some embodiments include hardware which replaces part or all of the identified software, consistent with the widely recognized general interchangeability of software and hardware.

Other aspects of the present invention will become more fully apparent through the following description.

### BRIEF DESCRIPTION OF THE DRAWINGS

To illustrate the manner in which the advantages and features of the invention are obtained, a more particular description of the invention will be given with reference to the attached drawings. These drawings only illustrate selected aspects of the invention and thus do not fully determine the invention's scope.

FIG. 1 is a diagram illustrating a previously known commerce architecture which includes an online auction provider, a poster who posts information about an item in an online auction, and bidders who bid on the item in the online auction.

FIG. 2 is a diagram illustrating a previously known commerce architecture which includes a charity, a raffle item donor, a raffle organizer, and raffle ticket buyers.

FIG. 3 is a diagram illustrating a commerce architecture according to the present invention, in embodiments which may include online marketplace providers, buyer item suppliers, buyers of buyer items, raffle item suppliers, and charitable organizations.

FIG. 4 is a flowchart illustrating methods of the present invention, including steps which may be performed by an online marketplace provider.

FIG. 5 is a flowchart illustrating methods of the present invention, including steps which may be performed by a raffle item supplier.

FIG. 6 is a flowchart illustrating methods of the present invention, including steps which may be performed by a buyer of buyer items which are not raffled.

FIG. 7 is a flowchart illustrating methods of the present invention, including steps which may be performed by a public or private charity.

FIG. 8 is a flowchart illustrating methods of the present invention, including steps which may be performed by a supplier of buyer items.

FIG. 9 is a diagram illustrating components of one embodiment of an online commerce system according to the present invention.

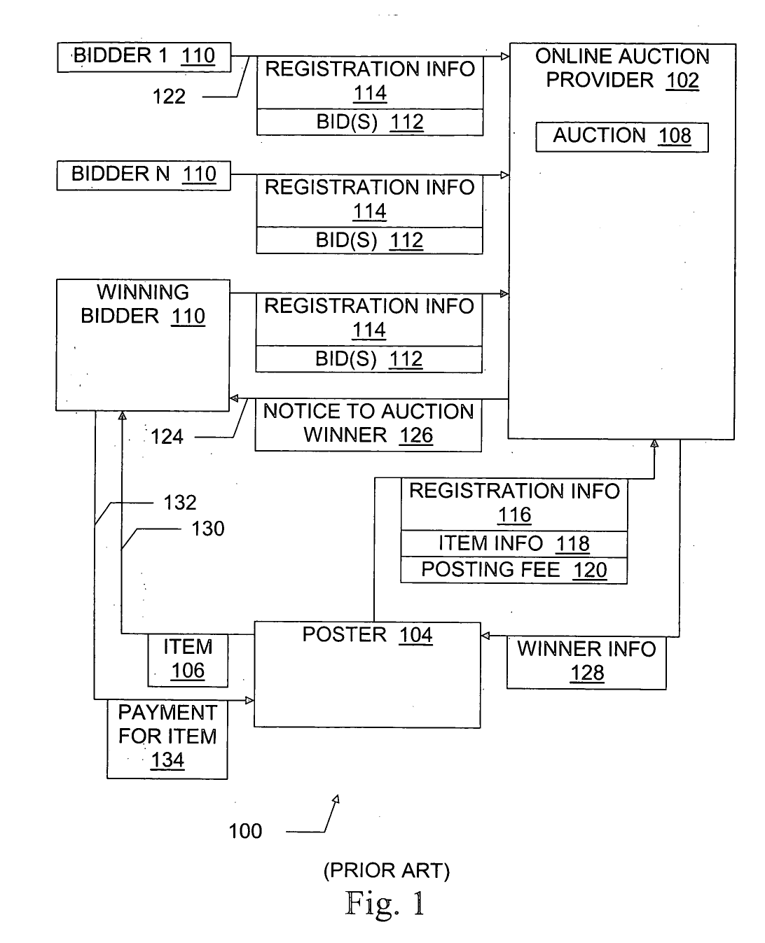

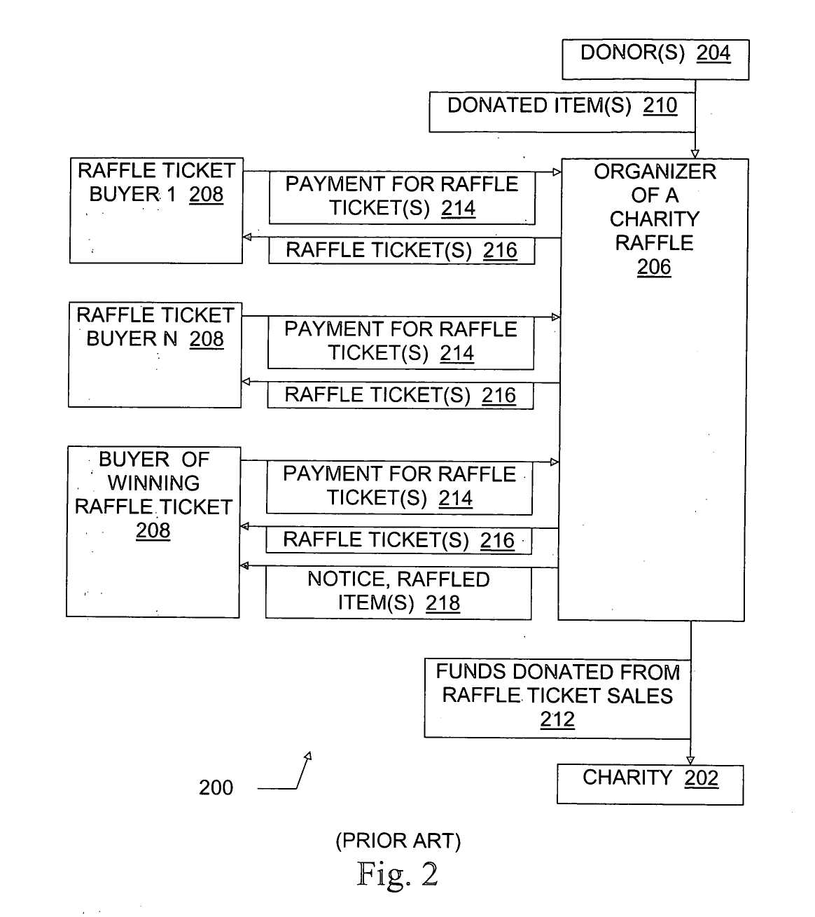

### DETAILED DESCRIPTION

Reference will now be made to exemplary embodiments such as those illustrated in the drawings, and specific language will be used herein to describe the same. But alterations and further modifications of the inventive features illustrated herein, and additional applications of the principles of the invention as illustrated herein, which would occur to one skilled in the relevant art(s) who has studied this disclosure, should be considered within the scope of the invention.

In describing the invention, the meaning of important terms is clarified, so the claims must be read with careful attention to these clarifications. Specific examples are given to illustrate aspects of the invention, but those of skill in the relevant art(s) will understand that other examples may also fall within the meaning of the terms used, and within the scope of one or more claims. Words used in this document do not necessarily have the same meaning they have in everyday usage. Terms may be defined, either explicitly or implicitly, here in the Detailed Description and/or elsewhere in this document or in the application file. It is not necessary for every means or aspect identified in a given definition or example to be present or to be utilized in every embodiment of the invention.

Terms such as “raffle”, “lottery”, “sweepstakes”, and “drawing” are used in various ways by various people to describe different contests of chance, including ways that are not necessarily consistent. Indeed, a given person's understanding of such terms, and hence their usage, may change over time. It is therefore helpful to focus on the actual structure and operation of the contest in question to avoid misunderstandings. A contest labeled with one name may be substantially equivalent, for the purpose at hand, to a contest labeled with a different name. Likewise, two contests may differ greatly in structure and/or operation even though they have been labeled by the same name.

Bearing this in mind, a distinction may be made between raffle contests and lottery contests, for example. It may be observed that in a lottery, the prize is typically money, whereas in a raffle the prize is generally one or more products and/or services. In a lottery, the amount of prize money often goes up as the number of lottery participants rises; in a raffle the prize is typically fixed and announced in advance of the selection of a winner. In practice, lotteries are often run by a government to generate revenue, so lotteries can be viewed as a form of voluntary taxation. By contrast, raffles have often been used by charitable organizations to raise money, so the primary motivation of raffle participants has been contributing to the charitable cause, not winning the raffle prize. In this context, the present invention is generally concerned with raffles rather than lotteries.

A distinction may also be made between raffles and drawings, although those terms may also be used interchangeably in casual conversation. In a drawing, every entrant has the same chance of winning based on possession of a single ticket, but in a raffle each of the individual entrants may improve their respective chance of winning by acquiring more raffle tickets. A drawing may be viewed as the particular type of raffle in which each entrant has the same number of raffle tickets. In this context, embodiments of the present invention may involve drawings, raffles, or both.

Commerce Architectures

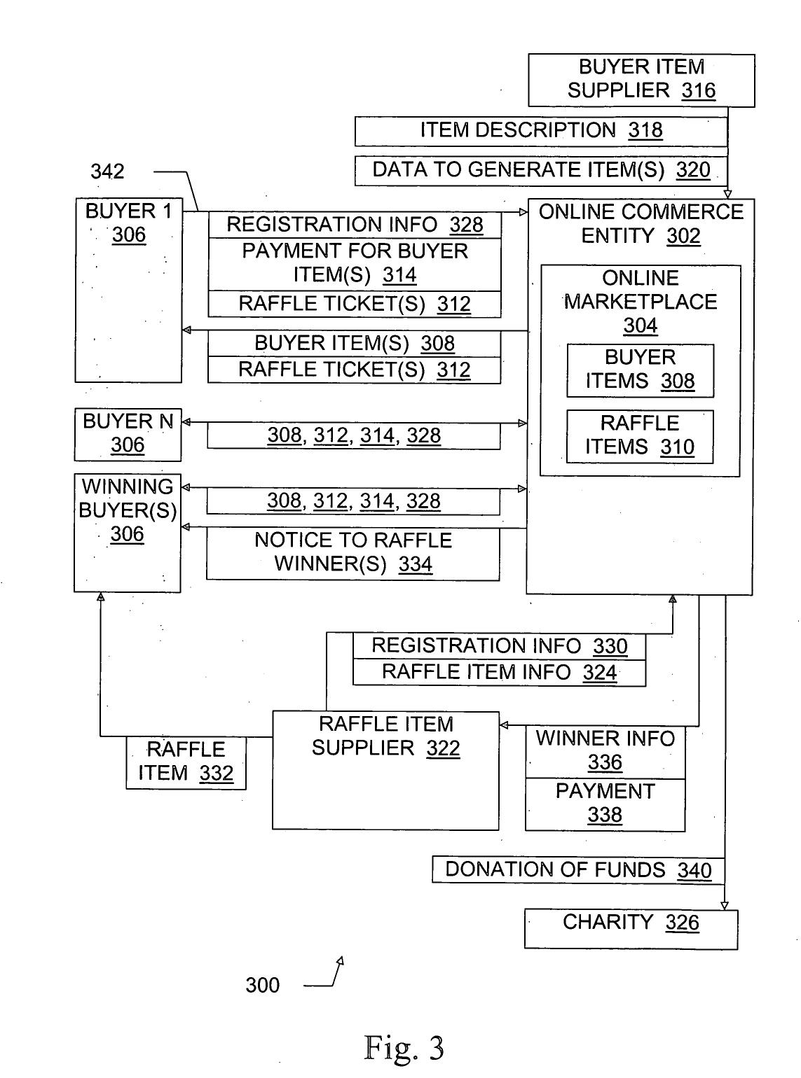

FIG. 3 is a diagram illustrating a commerce architecture 300 according to the present invention. The illustrated embodiment includes an online commerce entity 302 which provides an online marketplace 304 allowing buyers 306 to learn about and purchase buyer items 308. The marketplace 304 may also be referred to as an online trading platform. The online commerce entity is not merely an internet service provider or a payment processor but instead manages the online marketplace. The online commerce entity may be an individual person, an agency, an institution, a business or other legal person, or any other entity that is capable of legal acts such as owning property and entering binding agreements. Buyers and those who fill other roles in the commerce architecture 300 may likewise be any entity that is capable of legal acts pertaining to property rights.

The online marketplace may be implemented using the Internet and/or another computer network, such as a wired or wireless local area network, wide area network, virtual private network, or metropolitan area network, for instance. Network nodes may be desktop computers, servers, cell phones, and/or other networkable devices. Servers hosting the online marketplace may be located in a particular place, e.g., a jurisdiction where raffles are expressly legal, such as Alaska (that is the inventor's present understanding of Alaskan law). The network(s) can be equipped with other familiar online commerce infrastructure components 342, such as HTTPS and SSL protocols, browsers, XML software, database management software, credit card authorization tools, passwords and other authentication tools, encryption and other security tools, and so on. Suitable software for implementing the invention is readily provided by those of skill in the art using the teachings presented here and programming languages and tools such as Java, Pascal, C++, C, CGI, Perl, ASP, JSP, .Net, SQL, APIs, SDKs, assembly, firmware, microcode, and/or other languages and tools. To embody the invention, the computers, networks, protocols, and other known computer commerce technologies should be suitably selected, configured, and supplemented according to the teachings herein.

Suitable buyer items include any good, service, or other item in which legal rights can be transferred to a buyer in exchange for a payment 314. Such buyer items are virtually unlimited in choice, including any product or consumer item having value to the public. These might include books, clothing, sporting goods, vacation packages, restaurant discount coupons and other forms of coupon books, etc. Offered raffle items 310, like buyer items, can include any good, service, or other item in which legal rights can be transferred to a buyer. However, in a given marketplace 304 at a given time, buyer items are distinguishable from raffle items 310 in accordance With their role in the present invention. Unlike buyer items, raffle items are not sold in the marketplace 304. Instead, raffle items are raffled, subject to various conditions in a context that is described and claimed herein. Raffle items are raffled using raffle tickets 312, which buyers receive at no charge when they purchase buyer items 308. In theory, some other raffle ticket could be a buyer item or a raffle item, but to avoid confusion the particular raffle tickets 312 discussed herein are assumed to be neither buyer items nor raffle items. In some embodiments, buyers are repeatedly reminded that they are purchasing buyer items, not purchasing raffle tickets. In some embodiments, buyer item purchases are limited on credit card accounts, e.g., to US$5000 per month per account, but unlimited purchases may be allowed if payment is sent by courier.

In some embodiments, anyone over eighteen years old or otherwise over the applicable legal age of minority may write the online commerce entity, e.g., with a self-addressed stamped envelope, and request a, raffle ticket at no charge and without making a purchase. A limit may be placed on the number of raffle tickets entrants can obtain in this manner, e.g., one ticket per household. Raffle tickets which are not provided in electronic form may have an identifying number, possibly with an embedded checksum, for the entrant to provide electronically to the online commerce entity in order to enter the ticket in a raffle.

In some embodiments, the buyer items 308 include, and in some embodiments they are limited to, buyer items that can be delivered electronically. Such buyer items may take a variety of forms, including software, video, audio and other types of digital content, which could be emailed to the buyer, downloaded, and/or displayed in a browser or other viewer, and/or printed. Some of the many possibilities include discount coupons 308; quotes 308; jokes 308; comics 308; clip art 308; photos 308; and/or songs 308.

Buyer items may be supplied to the marketplace either directly or indirectly by a buyer item supplier 316. In some embodiments, the buyer item supplier and the online commerce entity are the same entity. In other embodiments, distinct buyer item suppliers supply the online commerce entity with descriptions 318 of buyer items, such as textual descriptions, reviews, photos, database records, SKU numbers, sound samples, thumbnail images, and so on. In addition, or as an alternative to supplying the buyer items directly, buyer item suppliers may supply them indirectly by supplying the online commerce entity with data and/or software 320 to be used to generate electronic buyer items, such as discount coupon generation software. Coupons may save buyers money at a variety of offline, retail, and/or Internet locations in a given jurisdiction such as the United States, Europe, or another region or country.

The commerce architecture 300 shown also includes at least one raffle item supplier 322. In some embodiments, the raffle item supplier and the online commerce entity are the same entity. In other embodiments, distinct raffle item suppliers supply the online commerce entity with descriptions 324 of raffle items, such as textual descriptions, reviews, photos, sound samples, thumbnail images, and so on. Although the claims are not necessarily so limited, it is contemplated that the raffle items will primarily be goods, and that the novel marketplace 304 will be an alternative venue for disposing of goods which are not disposed of through conventional marketplaces such as online auction 108 sites. A raffle item posting fee may be charged to list the item in a raffle online, but in some embodiments no posting fee is charged.

In some cases the online commerce entity may refuse to post items because of the type of item. For instance, illegal or highly controversial items may be refused listings 310. In some cases a listing 310 may be refused because the raffle item is overvalued, that is, the raffle item supplier has set an unrealistically high raffle participation level that must be reached for a raffle winner to be selected. An unrealistically high raffle participation goal may actually discourage participation in the raffle. With respect to cars submitted as potential raffle items, for example, a rule may be enforced that requires the raffle participation goal not map to a currency value that exceeds one-and-one-half times NAPA blue book high value. Items without blue books may be valued using similar item listings on online auction sites, and similarly restricted to avoid overvaluing. The online commerce entity will normally explain to the raffle item supplier why the desired listing 310 was not approved. The online commerce entity may offer revision suggestions, and may accept a suitably revised raffle item submission 324. A listing refusal appeals process may also be provided, or other measures may be provided to give raffle item suppliers an opportunity to advocate for their position.

The commerce architecture 300 shown also includes at least one charitable organization 326. The charity 326 may be, for instance, a public or private charity, a 501(c)(3) organization under the United States Internal Revenue Code, a non-profit organization, or any institution or organization whose primary purpose and funding are the relief of other people's suffering, poverty, lack of education, and/or otherwise serving the public interest, and which relies primarily on gifts for funding.

Subsequent discussion of methods of the invention will help explain the operation of the commerce architecture 300 and other commerce architectures and embodiments of the present invention. With regard to at least the commerce architecture 300, however, the following operational points may be noted here.

Buyer item suppliers supply buyer items to the online commerce entity, which offers them for sale in the online marketplace. Raffle item suppliers supply the online commerce entity with information about raffle items, and the raffle items are then offered in online raffles. Tickets for the raffles are provided to buyers at no charge, on registration and/or incidental to their purchase of buyer items. In some cases raffle tickets are tied to a particular raffle, but it is contemplated that some embodiments of the invention will provide raffle tickets that can be used in any of a variety of raffles; the buyer can then decide which raffle to use the raffle ticket(s) in, depending on the raffle prizes offered, timing, or other factors.

Buyers may be required to register with the online commerce entity by providing contact information and their agreement 328 to abide by the rules governing the online market 304. Raffle item suppliers may likewise be required to register by providing contact information and their agreement 330 to abide by the rules governing the online market 304, including their agreement to transfer a raffled item 332 to the winner of the raffle.

If specified raffle conditions are met, the winner of a given raffle is selected randomly by the online commerce entity (or equivalently by its appropriate agent such as an accounting firm) from among the buyers who have submitted tickets 312 in the raffle. The raffle winner is notified 334. The raffle item supplier is notified 336 and given the winner's contact information. After a raffle winner is chosen, some of the funds received by the online commerce entity may be kept by that entity, e.g., as a commission. Some funds 338 are sent to the raffle item supplier, and some funds 340 are donated to one or more charities. In one contemplated embodiment, the online commerce entity receives a commission of seventeen percent of funds collected, as mapped to a given qualifying threshold. In one embodiment, the buyer selects the charity that will receive a donation from a raffle winner at the time the buyer buys the buyer item for which the winning raffle ticket is incidentally given to the buyer.

Specified conditions for a raffle may include a requirement by the raffle item supplier or the online commerce entity that a certain number of tickets be submitted in the raffle by a certain date, for instance. The raffle supplier or the online commerce entity may also specify which charity will receive the donated funds, and how much the charity will receive.

As noted, a single entity may assume more than one of the roles shown in FIG. 3. Indeed, in some embodiments a single entity could be the buyer item supplier, the raffle item supplier, the charity, and the online commerce entity. More generally, commerce architecture components may be repeated, omitted, named differently, grouped differently, and/or connected differently than shown in FIG. 3, in manners which are consistent with the claims and the understanding of those of skill in the pertinent art(s).

Methods

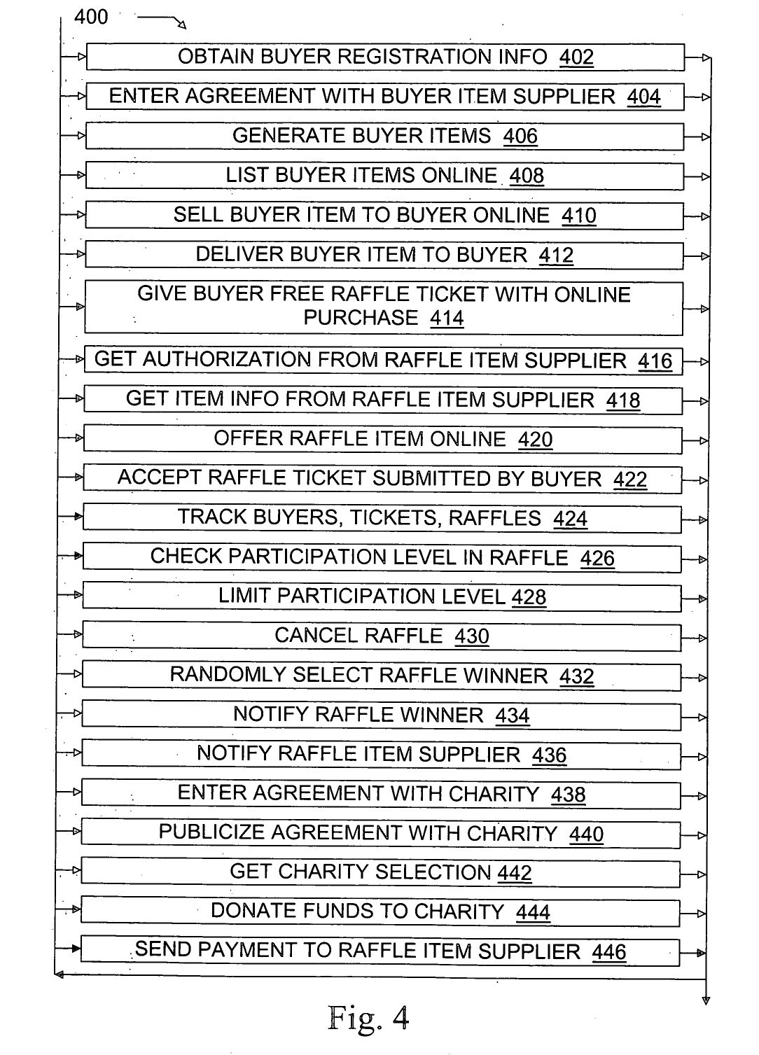

FIG. 4 is a flowchart 400 illustrating methods of the present invention, including steps which may be performed by an online marketplace provider such as online commerce entity 302. Online commerce methods are performed by an online commerce entity which manages an online marketplace such as marketplace 304 in which buyers purchase buyer items, or equivalently by the online commerce entity's agents, be they software or human.

FIG. 4 is not necessarily comprehensive. Inventive methods may include details not stated in the corresponding illustration of a step, and may include steps which are not illustrated in FIG. 4 but are described elsewhere herein or otherwise readily apparent to one of skill. It would be understood, for example, from FIG. 3 that inventive methods may comprise a step of obtaining raffle item supplier registration information, even though that step is not expressly shown in FIG. 4. More generally, and as reflected in the structure of the flowcharts, inventive methods may omit, include, repeat, perform concurrently or in series, re-order, supplement, and/or otherwise perform some or all of the illustrated steps so long as they do so in a manner consistent with the claims and other legal constraints. This holds true of all the figures; they illustrate particular embodiments but are not necessarily comprehensive, and not every embodiment need have every illustrated step, distinct participant, information, payment, or other illustrated component.

During a buyer registering step 402 the online commerce entity obtains buyer contact information, such as name and email address. Any necessary legal notices may be given, such as privacy policy notices, copyright notices, gaming commission notices, and so on. The buyer may also be given or directed to an explanation of the rules governing the online marketplace, such as how to make payment for buyer items, how to submit raffle tickets, whether raffle tickets are transferable to another person, whether raffle tickets expire if unused, whether raffle tickets may be transferred from one raffle to another, what type of raffle items are available and what type are prohibited, under what conditions a raffle will be canceled, how funds received by the online commerce entity are distributed, how to get help if someone is breaking the rules, and so on. The buyers will be asked to agree to act according to these rules, and they may be denied access to the raffles, to the market in buyer items, or both, if they refuse to agree to follow the rules. Similar steps or sub-steps may be taken with regard to raffle item suppliers, buyer item suppliers, and/or charities, during steps not expressly shown in FIG. 4, for registering those entities with the online marketplace. In some embodiments, everyone must register once, whether to buy items or to have them offered in the marketplace 304, in order to at least confirm their identity to the online commerce entity.

During a buyer-item-supplier-agreement-entering step 404, the online commerce entity and the buyer item supplier agree that the online commerce entity is permitted to advertise a buyer item for sale in the online marketplace. The buyer item supplier will expressly understand, from the text of an agreement or otherwise, that the online marketplace provides a buyer with at least one raffle ticket at no charge when the buyer buys a buyer item, and that the buyer can submit the ticket in a raffle online. The agreement may also address matters of the type generally found in distributor agreements, such as trademarks, payments, and the like. Similar agreement actions may be taken with regard to raffle item suppliers and/or buyers, during steps not expressly shown in FIG. 4, for obtaining their agreement to abide by the rules governing the online marketplace and the funds flowing through it.

During a buyer item generating step 406, the online commerce entity (or its agent) generates buyer item(s) using data and/or software provided by the buyer item supplier. For instance, discount coupons 308 could be generated by software which simply downloads a printable image of a coupon to a buyer's computer. The coupons could be alphanumerically serialized. The coupon's content could be selected by the software based on buyer age, gender, zip code, or other demographic information obtained during buyer registration. Electronically deliverable buyer items other than discount coupons could also be generated, such as a “quote of the day” generated in a round-robin or a random manner from a database of quotes.

During a listing step 408, the buyer items are listed 310 online in the marketplace. Buyer items may be listed with text and optional photos in a manner similar to the listing of items in existing online stores or existing online auction sites. Listed buyer items may be searchable by category and/or keyword. As noted, it is assumed for clarity that listed buyer items 308 are not raffle tickets.

During a selling step 410, the online commerce entity (acting perhaps as agent of the buyer item supplier) sells the buyer one or more buyer items. Buyer items may be paid for by credit card and/or other payment means in a manner similar to the payment means used in existing online stores and online auction sites.

During a delivering step 412, the buyer item is delivered to the buyer. Buyer items which are not electronically transmissible may be delivered by postal mail, courier, or by being picked up by the buyer at a buyer supplier's local store, for example. Buyer items which are electronically transmissible, such as digital coupons, software, and so on, may be delivered by email, by file or other download through a network connection, or by other electronic transmittal. For instance, electronic delivery may be accomplished by transferring digital information to the buyer's network node display memory where it can be displayed on a monitor or played on speakers by the buyer, and possibly also be printed by the buyer.

During a ticket-giving step 414, the online commerce entity gives buyers raffle tickets at no charge incidental to their purchase in the online marketplace of buyer items. In one example, a buyer purchases one hundred quotes for one dollar each, and receives both the purchased quotes and one hundred complimentary raffle tickets. The raffle tickets may be given 414 by electronically delivering them to the buyer, in which case digital signatures, checksums, and/or other familiar tools may be adapted for use in reducing the risk of altered or counterfeit raffle tickets. Alternately, a raffle ticket may be given by incrementing an “unused raffle ticket count” in a buyer's account which is maintained by the online commerce entity on behalf of the buyer.

The ticket giving step 414 may include giving buyers raffle tickets that are usable in any one of a plurality of raffles, unlike raffle tickets that are tied to a single raffle. That is, with some raffle tickets, particularly in conventional raffles, the choice of raffle is inherently made by the purchase or other mode of obtaining a raffle ticket. One buys a raffle ticket for a particular raffle. By contrast, some embodiments of the invention provide raffle tickets in which the choice of which raffle to use the ticket in can be made after the ticket is obtained. One is given a raffle ticket to be used in any of several raffles. Indeed, in some embodiments a ticket can be withdrawn from one raffle and used instead in a different raffle.

During an authorization-obtaining step 416, the online commerce entity gets authorization from the raffle item supplier to offer the raffle item in an online raffle for which tickets are given away at no charge in response to buyer item purchases made in an online marketplace. This may be implemented by displaying a textual notice, by presenting and enforcing a click-through agreement, or by other familiar means adapted for use according to the present invention.

During a raffle-item-information-obtaining step 418, the online commerce entity gets information about the raffle item from the raffle item supplier. In some embodiments, the information is obtained using a standard form; in others, the format is less rigid.

During a raffle-item-offering step 420, at least some of the obtained 418 information about the raffle item is posted in the marketplace 304. Software which tracks 424 the correspondence between raffle items, raffle tickets submitted, and the buyers who submitted them, is also initialized so the raffle item will be tracked. As noted, it is assumed for clarity that offered raffle items 310 are not raffle tickets.

Offered raffle items are denoted 310 in FIG. 3; these will be online descriptions rather than the actual items, since non-electronic goods can be offered in raffles. Raffled items are denoted 332 in FIG. 3; these are the actual items rather than their online descriptions.

During a raffle-ticket-accepting step 422, one or more raffle tickets are accepted for entry into a particular raffle. The marketplace, on behalf of the online commerce entity, accepts raffle tickets submitted by buyers for listed raffle items. This could be done by having the buyer who held the ticket email it to the online commerce entity, for example. It might also be done by having the buyer instruct the online commerce entity to move the ticket(s) by decrementing the buyer's account by an amount and incrementing a raffle account by the same amount.

In some embodiments, a raffle ticket may be used in any currently open raffle; in others ticket use is limited 428 so that a ticket may be used only in certain raffles, such as raffles in which the buyer has submitted less than twenty percent of the total submitted tickets. In some embodiments, a raffle ticket may not be withdrawn from a raffle once it is submitted; in others a raffle ticket may be transferred to another raffle but not refunded. In still other embodiments, a raffle ticket submitted in one raffle may be transferred to another raffle or it may be refunded for possible later use in a raffle that does not necessarily exist at the time the ticket is refunded.

During a tracking step 424, tracking software and/or hardware tracks which buyers submit raffle ticket(s) for each of a plurality of raffle items. Relational database, accounting, and/or other familiar software may be supplemented and otherwise adapted for tracking 424 according to the invention. Those of skill in computer arts generally, and in software arts, will appreciate that functionality may be divided between components in various ways that each provide desired results. For instance, tracking software need not be a separate program. It may instead be code that is divided between software that gives 414 buyers raffle tickets, software that accepts 422 raffle tickets, software that checks 426 the number of tickets submitted in a given raffle and compares it with the raffle item supplier's stated goal 324, software that limits 428 participation, software that cancels 430 a raffle if too few tickets have been submitted by a specified date, and winner-selecting 432 software.

During a participation-checking step, the online commerce entity or software operating on its behalf checks the level of raffle tickets submitted for participation in that raffle to determine whether the level has reached a positive qualifying threshold. The qualifying threshold may be stated 324 directly by the raffle item supplier, or it may be calculated from the raffle item supplier's stated 324 goal by considering factors such as how many tickets have been given out to buyers regardless of any particular raffle, how much buyer item payment 314 has been made regardless of any particular raffle, how much donation 340 a charity would receive if a particular raffle were held, and how much payment a raffle item supplier would receive if a particular raffle were held.

Note that the level of participation is checked, which is not necessarily the same as the number of raffle tickets submitted. The number of raffle tickets submitted and the level of raffle tickets submitted are the same if each raffle ticket is given the same weight; otherwise, the two may differ. For instance, in some embodiments a single raffle ticket can provide more than one chance of winning. Such raffle tickets have denominations in a manner similar to currency, but raffle tickets may be non-negotiable under applicable law so the analogy between raffle tickets and currency is limited.

During a participation-limiting step 428, participation in a raffle is limited by the online commerce entity or software operating on its behalf. For instance, a particular buyer may be prevented from increasing its participation in the raffle beyond a specified maximum individual allowed participation limit, such as a specified percentage of the total tickets submitted, or a specified percentage of the total desired participation. The system may also prevent each buyer from increasing participation in the raffle once the participation level reaches the qualifying threshold.

During a canceling step 430, a particular raffle is canceled. The submitted tickets may be refunded to buyers, partially refunded, or lost, depending on the embodiment or other factors, such as the agreement made by the online commerce entity with a particular buyer. The raffle may be canceled because insufficient tickets have been submitted by a specified date or (equivalently) within a specified period of time, e.g., thirty days after the raffle is opened 420. Likewise; the raffle may be canceled if a qualifying threshold is not reached by a specified deadline.

During a winner-selecting step 432, the online commerce entity or its agent randomly selects a raffle winner from among the buyers who are participating in a given raffle. The winner may be selected only if a check 426 shows the level of raffle tickets submitted for participation in that raffle has reached and stayed above the positive qualifying threshold for that raffle. Familiar raffle winner selection tools, including software, wire cage draws, and other tools that produce results considered random under applicable law if used properly, may be adapted for use according to the invention.

During a winner-notifying step 434, an email, a posting, or another communication means is used to notify the selected 432 winner. The notice may also present or repeat data or procedures to be used for the winner to receive the raffle prize, e.g., how to contact the raffle item supplier or how to download the prize.

During a raffle-item-supplier-notifying step 436, email, posting, or other communication means is used to notify the raffle item supplier about the selected winner. The notice may also present or repeat data or procedures to be used for the raffle item supplier to send the winner the raffle prize, e.g., the winner's email address or other contact information. The raffle item supplier may be told that payment 338 will not be sent to the raffle item supplier until the raffle winner confirms receipt of the raffle prize. That is, the payment 338 may be held in escrow until the online commerce entity receives proof that the raffled item has been delivered to the raffle winner. The payment 338 may be less a commission to the online commerce entity, less a donation to charity, or less both amounts.

In some embodiments, measures are provided to allay concerns that may be felt by raffle item suppliers whose raffle items have value over some specified amount, e.g., US$2000. Suppliers of such high-value raffle items may request that payment 338, or a specified portion of payment 338, be provided to them before they ship the raffled item to the raffle winner. In response, the online commerce entity may advance payment to the raffle item supplier, out of an internal escrow account, for example.

During a charity-agreement-entering step 438, the online commerce entity and the charity agree that the online commerce entity is permitted to publicize an arrangement between the charity and the online commerce entity. This may be done, for instance, by publicizing that the charity will receive donations from the online commerce entity in response to buyer participation in a raffle whose tickets are given at no charge to buyers in response to their purchase of buyer items in the online marketplace. The agreement may also address matters such as trademarks or the charity's tax status.

During a publicizing step 440, the online commerce entity publicizes an arrangement between the charity and the online commerce entity. For instance, the marketplace may contain posted text explaining that the charity will receive donations from the online commerce entity in response to buyer participation in a raffle, and that the raffle tickets are given at no charge to buyers in response to their purchase of buyer items in the online marketplace. Other publicity tools, such as print or television/radio commercials, direct mail, email, and the like may be adapted to publicize the arrangement.

During a charity-selection-obtaining step 442, the online commerce entity obtains a charity selection. Selection may be done by the raffle item supplier, by the buyer, or by another party, and may be done by selecting the charity from a searchable list of common charities with whom the online commerce entity has an agreement 438, or other charities.

During a donating step 444, funds 340 are donated to the selected charity. This may be done by electronic funds transfer or other payment means. The donation is made by the online commerce entity pursuant to the arrangement made 438 between the charity and the online commerce entity. The charitable donation may be made as part of a given raffle if a raffle winner is selected for that raffle.

During a raffle-item-supplier-paying step, the raffle item supplier is paid by the online commerce entity for use of the raffle item in the online marketplace. Payments such as payments 314, 338, 340 may be by credit card, electronic funds transfer, through an online payment processor, or by other familiar payment means used according to the teachings herein.

In some embodiments, the online commerce entity acts as an escrow house for the raffles. That is, the online commerce entity does not supply raffle items, does not ship raffle items to raffle winners, and does not participate in the raffles as a buyer or potential winner, but instead coordinates the raffle-related activities of others as discussed herein.

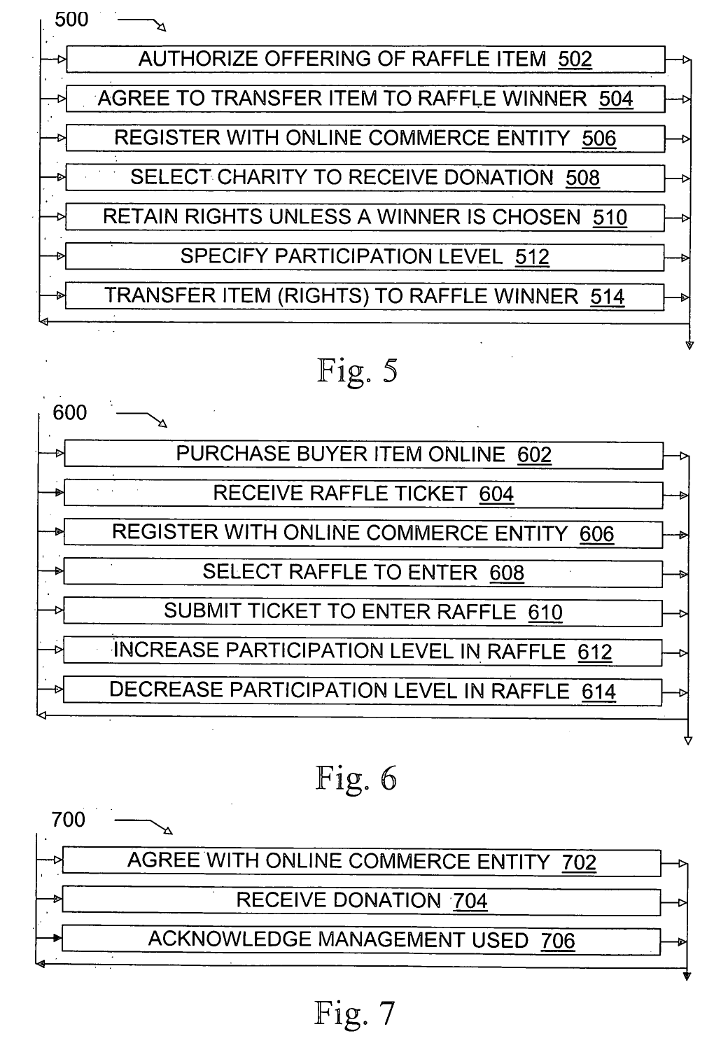

As noted, FIG. 4 illustrates embodiments of the invention from the online commerce entity's perspective. FIGS. 5 through 8 contain flowcharts illustrating embodiments of the invention from other points of view: raffle item supplier, buyer, charity, and buyer item supplier, respectively. However, each of these flowchart figures helps one understand the other flowchart figures. For instance, teachings herein about getting 416 authorization from a raffle item supplier are helpful in understanding a raffle item supplier step 502 of authorizing the offering of a raffle item. Indeed, the helpfulness of teachings is not limited to the method figures. For instance, the discussion above of FIG. 3's buyer registration information 328 helps illustrate a FIG. 6 buyer registering step 606. Likewise, understanding of a commerce system 900 is aided by understanding methods shown in FIGS. 4 through 8 and by understanding the commerce architecture shown in FIG. 3. To improve understanding and reduce repetition, therefore, the discussion of each figure should be informed—though not necessarily limited—by the discussions of the other figures.

FIG. 5 is a flowchart 500 illustrating methods of the present invention, including steps which may be performed by a raffle item supplier such as supplier 322, or equivalently by a human or computer agent of the raffle item supplier. The raffle item supplier has legal rights in a raffle item. The rights may be full ownership rights, or they may be more limited rights such as a rental, copying, or distribution right.

During an authorizing step 502, the raffle item supplier authorizes an online commerce entity to offer the raffle item in an online raffle for which tickets are given away at no charge in response to buyer item purchases made in an online marketplace. Step 502 may be the raffle item supplier counterpart of online commerce entity step 416.

During an agreeing step 504, the raffle item supplier agrees to transfer legal rights to a raffle winner if one is randomly selected from among parties who are given raffle tickets in the online marketplace. The transfer need not actually occur for step 504 to occur. However, transfer may be accomplished as discussed in connection with raffle item 332.

During a registering step 506, the raffle item supplier provides registration information and agrees to be bound by the rules governing the raffle. This may be accomplished as discussed in connection with registration information 330.

During a charity-selecting step the raffle item supplier selects a charity to which a specified donation will be made if a raffle winner is selected. This may be accomplished as discussed in connection with step 442.

During a rights-retaining step 510, the raffle item supplier retains the legal rights if the raffle is canceled. This distinguishes the legal status of a raffle item from situations in which a person simply donates something outright to a charity and thus retains no rights in the donated item regardless of whether the charity raffles the item or does something else with it. As discussed, the raffle may be canceled 430 due to a relative lack of interest from parties to whom raffle tickets are given in the online marketplace. The parties may have a choice of raffles, with a corresponding choice of different raffle items, in any one of which raffles a particular raffle ticket may be used.

During a participation-level-specifying step, the raffle item supplier states 324 a goal for the level of buyer participation in a given raffle. The goal specifies a minimum amount of interest in the raffle item that must be shown by parties who have raffle tickets before a raffle winner can be selected. As discussed, the raffle item supplier may state the qualifying participation threshold as the goal, or the qualifying threshold may be calculated based in part on the raffle item supplier's stated goal.

During a transferring step 514, the raffle item supplier transfers legal rights in the raffle item 332 to the selected raffle winner or winners. This transfer 514 may be accomplished as discussed in connection with raffle item 332, e.g., by email, postal mail, or courier. Thus, the raffle item supplier may be responsible for shipping the raffled item to the raffle winner. Transfer could also involve signing of legal transfer or title documents, in addition to changes in possession. To aid calculation of shipping costs, buyers may be restricted to those residing in certain locations, e.g., the United States and Canada for a marketplace 304 hosted or marketed in North America, or Europe for a marketplace 304 directed to Europeans. The raffle item supplier is responsible for shipping costs in some embodiments.

FIG. 6 is a flowchart 600 illustrating methods of the present invention, including steps which may be performed by a buyer such as one of the buyers 306, or equivalently by a human or computer agent of the buyer.

During a purchasing step 602, the buyer purchases a buyer item in an online marketplace. The purchasing step may comprise purchasing an electronically delivered item, such as a coupon or a copyrightable work. This step 602 may be accomplished as discussed in connection with FIG. 3 and step 410, for example.

During a receiving step 604, the buyer receives a raffle ticket which is given at no charge incidentally to the purchase of the buyer item. The raffle ticket may be tied to particular raffle, or to specified subset of raffles, or it may be usable in any one of a plurality of raffles which offer different raffle items as their respective prizes. The receiving step 604 may be accomplished as discussed in connection with FIG. 3 and step 414, for example.

During a registering step 606, the buyer provides registration information and agrees to be bound by the rules governing the raffle. Registering to use the online marketplace may include at least providing buyer contact information to an online commerce entity that manages the online marketplace. Registration may be accomplished as discussed in connection with registration information 328 and step 402, for example. A registration fee may be charged to buyers, to raffle item suppliers, or both.

Free raffle tickets may be provided to a registrant incidental to registration, not merely incidental to purchase of a buyer item. In some embodiments a registrant receives unlimited buying privileges in the online market place, or unlimited raffle item posting privileges, or both.

During a raffle-selecting step 608, the buyer selects a raffle to enter. This may be accomplished by browsing the offered raffles 310, for example, and may be implicit in a step 610 of submitting at least one raffle ticket for use in a raffle to increase the buyer's chance of being selected as a winner of that raffle. In some embodiments raffles may have multiple winners. Raffle selection may be accomplished as discussed in connection with FIG. 3 and steps 420, 422, for example.

Submitting 610 a ticket implicitly increases 612 the buyer's participation level in the selected raffle. For instance, the buyer may increase participation in a selected raffle, which is one of a plurality of raffles, by submitting multiple raffle tickets for use in the selected raffle. In some embodiments, a buyer may decrease 614 the buyer's participation level in the selected raffle by withdrawing one or more previously submitted tickets, as noted in connection with step 422, for example.

During a rights-obtaining step not shown in FIG. 6, the buyer may also obtain legal rights in a raffled item after winning a raffle with a ticket submitted in the submitting step 610. In one embodiment, the rights-obtaining step is the buyer's counterpart to the raffle item supplier's rights-transferring step 514.

FIG. 7 is a flowchart 700 illustrating methods of the present invention, including steps which may be performed by a charity such as the charity 326, or equivalently by a human or computer agent of the charity. In one embodiment, an agreement-entering step 702 is the charity's counterpart of online commerce entity step 438, and a donation-receiving step 704 is the charity's counterpart of online commerce entity step 444. These steps may also be understood by reference to FIG. 3.

In an acknowledging step 706, the charity acknowledges the nature of the online commerce entity's oversight, which may be important to do in some jurisdictions to maintain the trademarks and/or tax-free status of the charity. Depending on the facts, the charity may acknowledge that the online commerce entity manages the online marketplace directly in day-to-day operations, that the online commerce entity sponsors the online marketplace, and/or that the online commerce entity manages the online marketplace by monitoring the online marketplace. If the charity assumes the role of online commerce entity, then the acknowledging step 706 may be performed by representing to the public the manner (direct day-to-day, as sponsor, as monitor, or otherwise) in which it manages the online marketplace.

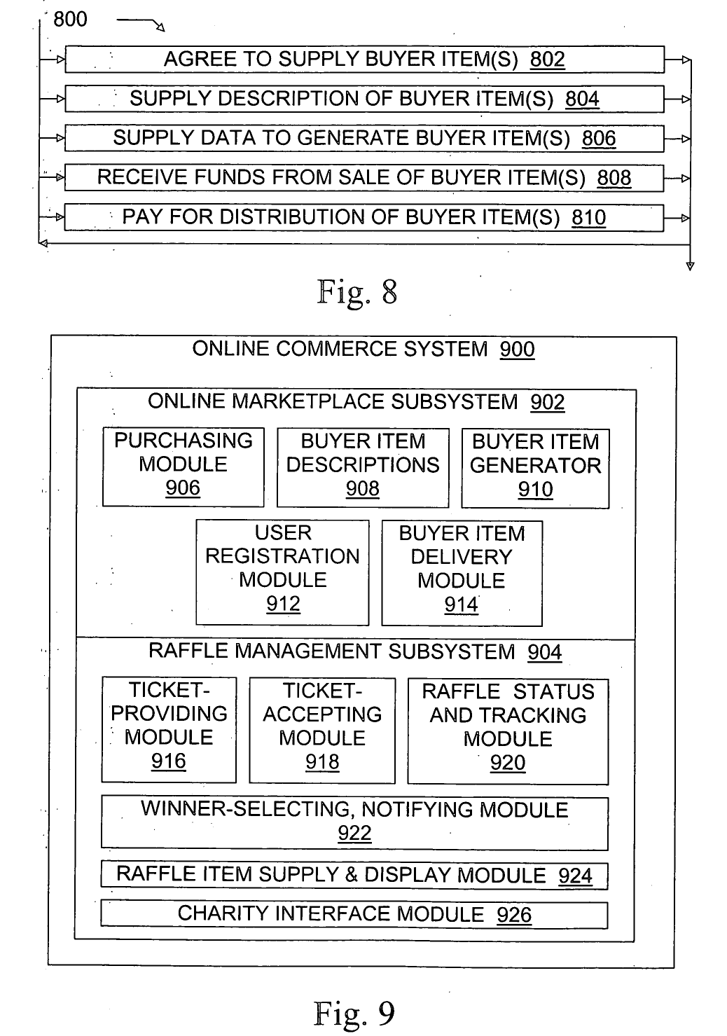

FIG. 8 is a flowchart 800 illustrating methods of the present invention, including steps which may be performed by a buyer item supplier such as the buyer item supplier 316, or equivalently by a human or computer agent of the buyer item supplier. In one embodiment, an agreement-entering step 802 is the buyer item supplier's counterpart of online commerce entity step 404; a buyer-item-description-supplying step 804 supplies an item description 318; and a buyer-item-data-supplying step 806 supplies data 320 to generate buyer items 308, which may be accomplished as discussed in connection with step 406.

In one embodiment, agreement-entering step 802 includes entering an agreement with an online commerce entity which expressly permits the online commerce entity to advertise a buyer item for sale in an online marketplace that provides a buyer with at least one raffle ticket at no charge when the buyer buys the buyer item and allows the buyer to submit the ticket in any one of a plurality of raffles. In one embodiment, buyer-item-description-supplying step 804 supplies a description of the buyer item to the online commerce entity to assist in advertising the item in the online marketplace.

In one embodiment, buyer-item-data-supplying step 806 supplies data to the online commerce entity, with which data the online commerce entity generates an electronically delivered buyer item. In some cases, the online commerce entity generates a coupon 308 that is electronically delivered 412 to a buyer. In some cases, the online commerce entity generates an image 308 that is electronically delivered to a buyer. In some cases, the online commerce entity generates a copy of a copyrightable work 308, and the copy is electronically delivered to a buyer.

Embodiments may include different payment arrangements between the buyer item supplier and the online commerce entity. In some cases, the buyer item supplier may receive 808 funds from the online commerce entity as a result of the sale 410 of buyer items to buyers. This may happen, for instance, when the buyer items are songs, pictures, software, or other copyrightable works difficult to create. In other cases, the buyer item supplier may pay 810 the online commerce entity to distribute the buyer items; this might happen, for instance, if the buyer items 308 are discount coupons to be used in purchasing goods manufactured by the buyer item supplier.

The steps and other characteristics described herein may be combined in various ways to form embodiments of the invention. In methods of the invention, steps may be omitted, repeated, renamed, supplemented, performed in serial or parallel, and/or grouped differently, except as required by the claims and to provide an operable embodiment. In particular, not every step illustrated in FIGS. 4 through 8 need be performed in a given method according to the invention.

System Components and Systems

FIG. 9 is a diagram illustrating components of one embodiment of an online commerce system 900 according to the present invention. To the extent that hardware, software, and firmware implementations are deemed partially or fully interchangeable at the time in question (now or hereafter) by one of skill in the art, they may be utilized in embodying the invention even though the specific implementation examples discussed here are different.

The online commerce system 900 corresponds generally to the online marketplace 304, but further illustrates the availability of different allocations of functionality amongst modules that implement an embodiment of the invention. For instance, in the embodiment illustrated in FIG. 9, the functionality for managing buyer items is organized into an online marketplace subsystem 902 and the functionality pertaining more closely to raffles is in a raffle management subsystem 904. However, other organizations which are adequately consistent with the illustrated methods and other teachings herein may also be used.

A purchasing module 906 includes software and/or hardware making it possible for buyers to purchase online buyer items that are not raffle tickets. This module may operate as discussed in connection with FIG. 3 and steps 408, 410, for example.

A module 908 of buyer item descriptions may have a database, possibly encrypted or otherwise secured, of descriptions 318 that were supplied 804 by buyer item suppliers 316. This module 908 may include software for searching, updating, categorizing, and otherwise managing buyer item descriptions.

A buyer item generator module 910 may include software and/or hardware which operates as discussed in connection with data 320 and steps 406, 806, for example.

A user registration module 912 may include software and/or hardware which operates as discussed in connection with registration information 328, 330 and steps 402, 506, 606, for example. In some embodiments, charities and/or buyer item suppliers may also be registered via registration module 912.

A buyer item delivery module 914 electronically sends an electronically deliverable buyer item (e.g., software, coupon, picture file, printable image, song) purchased with the purchasing module. The buyer item is sent to the buyer or to an address specified by the buyer, e.g., if the purchased item is a gift. Module 914 may include software and/or hardware which operates as discussed in connection with infrastructure 342 and steps 412, 514, for example.

A ticket-providing module 916 gives buyers raffle tickets at no charge incidental to their online purchase of buyer items. Module 916 may include software and/or hardware which operates as discussed in connection with tickets 312 and steps 414, 604, for example. It may also give registrants free raffle tickets incidental to their registration with the online commerce entity, when they pay a registration fee to buy access to activities in the marketplace.

A ticket-accepting module 918 accepts raffle tickets submitted by buyers. In some embodiments, module 918 tracks which buyers submit raffle ticket(s) for each of a plurality of raffle items; in others that is done by a raffle status and tracking module. Module 918 and module 920 if present may include software and/or hardware which operates as discussed in connection with FIG. 3 and steps 422, 424, 426, 610, for example.

In some embodiments, the ticket-accepting module cancels the raffle if the qualifying threshold is not exceeded on a specified date. In some, the ticket-accepting module prevents a particular buyer from increasing its participation in the raffle beyond a specified maximum individual allowed participation limit, e.g., twenty percent of the qualifying threshold. In some, the ticket-accepting module prevents each buyer from joining or otherwise increasing its participation in the raffle after the level of participation reaches the qualifying threshold unless the level of participation becomes lower than the qualifying threshold due to at least one of: (a) withdrawal of a ticket, e.g., if a buyer transfers the ticket to another raffle or simply wants it refunded for use in a raffle not yet chosen, and (b) an increase in the qualifying threshold, e.g., if a raffle item seller increases the desired participation level for a raffle. In some cases, the ticket-accepting module allows the buyer to withdraw a ticket submitted by the buyer in a first raffle, and to submit the ticket instead in a second raffle. As noted, other modules may also perform one or more of these functions according to the invention.

A winner-selecting module 922 randomly selects a raffle winner from among the buyers who are participating in a given raffle. In some embodiments, the winner is selected only if the level of raffle tickets submitted for participation in that raffle reaches a positive qualifying threshold. In some embodiments, the functionality in module 922 is placed instead in other modules, such as the raffle status and tracking module 920. As noted, and as well understood in the art, the allocation of functional tasks among modules within a system is a different matter than the presence or absence of particular functionality in the system considered as a whole. Module 922 if present may include software and/or hardware which operates as discussed in connection with communications 334, 336 and steps 432, 434, 436, 512, for example.

A raffle item supply and display module 924 may be used for registering a raffle item supplier, obtaining information about a raffle item, and/or obtaining the raffle item supplier's authorization to offer the raffle item in an online raffle for which raffle tickets are given away with buyer online purchases. Such a module may include software and/or hardware which operates as discussed in connection with objects 332, 324, 310 and steps 416, 418, 420, 502, 504, for example.

A charity interface module 926 may include software and/or hardware which operates as discussed in connection with FIG. 3 and steps 438, 440, 442, 444, 508, 702, 704, 706, for example. For instance, module 926 makes a charitable donation as part of a given raffle if a raffle winner is selected for that raffle. Some embodiments include a charity-selecting module with which a buyer, raffle item supplier, online commerce entity, or other entity or mechanism (e.g., public vote) can select a charity to which a specified donation will be made if a raffle winner is selected.

Conclusion

This document is a description of the invention pursuant to patent laws. It is not a business plan, a prospectus, or a representation as to the commercial benefits of any particular implementation of the invention, including embodiments that may be authorized under patent law by the inventor or patent owner. It is not a legal opinion on the legality of raffling or any aspect of the invention, or on any embodiment of the invention, whether limited to the claims or a substantial supplementation thereof. The inventor and the inventor's patent counsel offer no binding opinion here as to the legality of the invention in a particular jurisdiction. The inventor believes that embodiments of the invention may be adapted to the cultures and laws of various jurisdictions. Operating the online marketplace under the auspices of a particular jurisdiction, such as those covering Native American lands, United Kingdom Channel Islands, federal lands in the United States, the state of Alaska, and so forth, or operating partially in international waters, may provide legal benefits. But to the extent, if any, that laws other than patent law per se might bear on the patentability of the invention, patent counsel respectfully await action by the patent examiner(s) charged with examination of this application.

Headings herein are for convenience only; information on a given topic may be found outside the section whose heading indicates that topic. All claims as filed are part of the specification and thus help describe the invention, and repeated claim language may be inserted outside the claims as needed.

It is to be understood that the above-referenced embodiments are illustrative of the principles of the present invention. Numerous modifications and alternative embodiments can be devised without departing from the spirit and scope of the present invention. While the present invention has been shown in the drawings and described above in connection with the exemplary embodiments of the invention, it will be apparent to those of ordinary skill in the art that numerous modifications can be made without departing from the principles and concepts of the invention as set forth in the claims.

As used herein, terms such as “a” and “the” and designations such as “raffle ticket” and “giving” are inclusive of one or more of the indicated item or step. In particular, in the claims a reference to any object generally means at least one such object is present and a reference to a step means at least one instance of the step is performed.

The scope of the invention is indicated by the appended claims rather than by the foregoing description. All changes which come within the meaning and range of equivalency of the claims are to be embraced within their scope to the full extent permitted by law.

1. An online commerce method performed by an online commerce entity which manages an online marketplace in which buyers purchase buyer items, the method comprising the steps of:
giving buyers raffle tickets at no charge incidental to their purchase in the online marketplace of buyer items which are not raffle tickets;
listing online raffle items which are not raffle tickets;
accepting raffle tickets submitted by buyers for listed raffle items;
tracking which buyers submit raffle ticket(s) for each of a plurality of raffle items; and
randomly selecting a raffle winner from among buyers who are participating in a given raffle, the winner being selected only if the level of raffle tickets submitted for participation in that raffle reaches a positive qualifying threshold.

2. The method of claim 1, further comprising the step of making a charitable donation as part of a given raffle if a raffle winner is selected for that raffle.

3. The method of claim 1, further comprising the step of canceling the raffle if the qualifying threshold is not reached by a specified deadline.

4. The method of claim 1, further comprising the step of preventing a particular buyer from increasing its participation in the raffle beyond a specified maximum individual allowed participation limit.

5. The method of claim 1, further comprising the step of preventing each buyer from increasing its participation in the raffle if the level of participation is not lower than the qualifying threshold.

6. The method of claim 1, wherein the step of giving buyers raffle tickets comprises giving buyers raffle tickets that are usable in any one of a plurality of raffles.

7. An online commerce method performed by a raffle item supplier who has legal rights in a raffle item, the method comprising the steps of:
authorizing an online commerce entity to offer the raffle item in an online raffle for which tickets are given away at no charge in response to buyer item purchases made in an online marketplace;
agreeing to transfer legal rights to a raffle winner if one is randomly selected from among parties who are given raffle tickets in the online marketplace; and
retaining the legal rights if the raffle is canceled due to a relative lack of interest from parties to whom raffle tickets are given in the online marketplace, the parties having a choice of raffles, with a corresponding choice of different raffle items, in any one of which raffles a particular raffle ticket may be used.

8. The method of claim 7, further comprising selecting a charity to which a specified donation will be made if a raffle winner is selected.

9. The method of claim 7, further comprising specifying a minimum amount of interest in the raffle item that must be shown by parties who have raffle tickets before a raffle winner can be selected.

10. The method of claim 7, further comprising transferring legal rights to a selected raffle winner.

11. An online commerce method performed by a buyer, the method comprising the steps of:
purchasing a buyer item in an online marketplace;
receiving a raffle ticket which is given at no charge incidentally to the purchase of the buyer item and which is usable in any one of a plurality of raffles which offer different raffle items as their respective prizes; and
submitting the raffle ticket for use in one of the plurality of raffles to increase the buyer's chance of being selected as a winner of that raffle.

12. The method of claim 11, further comprising registering to use the online marketplace by at least providing buyer contact information to an online commerce entity that manages the online marketplace.

13. The method of claim 11, further comprising increasing participation in a selected raffle, which is one of a plurality of raffles, by submitting multiple raffle tickets for use in the selected raffle.

14. The method of claim 11, further comprising decreasing participation in a raffle and receiving a refunded raffle ticket that is usable in another raffle.

15. The method of claim 11, further comprising requesting that a raffle ticket be transferred from one raffle to another raffle.

16. The method of claim 11, wherein the purchasing step comprises purchasing an electronically delivered item.

17. The method of claim 16, wherein the electronically delivered item comprises a coupon.

18. The method of claim 16, wherein the electronically delivered item comprises a copyrightable work.

19. The method of claim 11, further comprising obtaining legal rights in a raffle item after winning a raffle with a ticket submitted in the submitting step.

20. An online commerce method performed by a charity, the method comprising the steps of:
entering an agreement with an online commerce entity which expressly permits the online commerce entity to publicize an arrangement between the charity and the online commerce entity by at least publicizing that the charity will receive donations from the online commerce entity in response to buyer participation in a raffle whose tickets are given at no charge to buyers in response to their purchase of buyer items in an online marketplace managed by the online commerce entity; and
receiving a donation from the online commerce entity pursuant to the arrangement between the charity and the online commerce entity.

21. The method of claim 20, wherein the charity acknowledges that the online commerce entity is managing the online marketplace by doing at least one of: sponsoring the online marketplace, monitoring the online marketplace, and managing the online marketplace directly in day-to-day operations.

22. An online commerce method performed by a buyer item supplier, the method comprising the steps of:
entering an agreement with an online commerce entity which expressly permits the online commerce entity to advertise a buyer item for sale in an online marketplace that provides a buyer with at least one raffle ticket at no charge when the buyer buys the buyer item and allows the buyer to submit the ticket in any one of a plurality of raffles; and
supplying a description of the buyer item to the online commerce entity to assist in advertising the item in the online marketplace.

23. The method of claim 22, further comprising the step of receiving funds from a purchase of the buyer item by a buyer in the online marketplace.

24. The method of claim 22, further comprising the step of paying the online commerce entity for distributing the buyer item.

25. The method of claim 22, further comprising the step of supplying data to the online commerce entity, with which data the online commerce entity generates an electronically delivered buyer item.

26. The method of claim 25, wherein the step of supplying data comprises supplying data with which the online commerce entity generates a coupon that is electronically delivered to a buyer.

27. The method of claim 25, wherein the step of supplying data comprises supplying data with which the online commerce entity generates an image that is electronically delivered to a buyer.

28. The method of claim 25, wherein the step of supplying data comprises supplying data with which the online commerce entity generates a copy of a copyrightable work, and the copy is electronically delivered to a buyer.

29. An online commerce system comprising:
a purchasing module for buyers to purchase online buyer items that are not raffle tickets;
a ticket-providing module which gives buyers raffle tickets at no charge incidental to their online purchase of buyer items;
a ticket-accepting module which accepts raffle tickets submitted by buyers and tracks which buyers submit raffle ticket(s) for each of a plurality of raffle items; and
a winner-selecting module which randomly selects a raffle winner from among the buyers who are participating in a given raffle, the winner being selected only if the level of raffle tickets submitted for participation in that raffle reaches a positive qualifying threshold.

30. The system of claim 29, further comprising a delivering module which electronically sends an electronically deliverable buyer item purchased with the purchasing module.

31. The system of claim 29, further comprising a donating module which makes a charitable donation as part of a given raffle if a raffle winner is selected for that raffle.

32. The system of claim 29, wherein the ticket-accepting module cancels the raffle if the qualifying threshold is not exceeded on a specified date.

33. The system of claim 29, wherein the ticket-accepting module prevents a particular buyer from increasing its participation in the raffle beyond a specified maximum individual allowed participation limit.

34. The system of claim 29, wherein the ticket-accepting module prevents each buyer from joining or otherwise increasing its participation in the raffle after the level of participation reaches the qualifying threshold unless the level of participation becomes lower than the qualifying threshold due to at least one of: withdrawal of a ticket, increase in the qualifying threshold.

35. The system of claim 29, wherein the ticket-accepting module allows the buyer to withdraw a ticket submitted by the buyer in a first raffle, and to submit the ticket instead in a second raffle.

36. The system of claim 29, wherein the ticket-providing module provides a registrant with a raffle ticket at no charge incidental to a registration to use the purchasing module.

37. The system of claim 29, further comprising a raffle item supplier management module for registering a raffle item supplier, obtaining information about a raffle item, and obtaining the raffle item supplier's authorization to offer the raffle item in an online raffle for which raffle tickets are given away with buyer online purchases.

38. The system of claim 29, further comprising a charity-selecting module with which one can select a charity to which a specified donation will be made if a raffle winner is selected.

39. The system of claim 29, wherein at least one of the modules includes software.
